(19) United States
(12) Patent Application Publication
(10) Pub. No.: US 2021/0010287 A1
(43) Pub. Date: Jan. 14, 2021

(54) TELECOMMUNICATIONS POLE PORTHOLE REINFORCEMENT

(71) Applicant: Tower Engineering Solutions, LLC, Las Vegas, NV (US)

(72) Inventors: Hanming You, Irving, TX (US); Jaime Reyes, Grapevine, TX (US)

(21) Appl. No.: 16/505,076

(22) Filed: Jul. 8, 2019

(51) Int. Cl. E04H 12/00; E04H 12/08

(52) U.S. Cl. CPC E04H 12/003; H01Q 1/1242; E04H 12/08

(57) ABSTRACT

A porthole reinforcement is configured to attach to a telecommunications pole defining a porthole. The porthole reinforcement includes a first reinforcement segment comprising a first gusset configured to at least partially extend through the porthole and a first plate attached to the first gusset, the first plate defining a first plurality of bores each configured to receive a respective bolt so as to couple the first reinforcement segment to the telecommunications pole. The porthole reinforcement segment also includes a second reinforcement segment comprising a second gusset configured to at least partially extend through the porthole and a second plate attached to the second gusset, the second plate defining a second plurality of bores each configured to receive a respective bolt so as to couple the second reinforcement segment to the telecommunications pole. The first and second reinforcement segments are configured to attach to the telecommunications pole independently from each other.

### TECHNICAL FIELD

The present disclosure generally relates to porthole reinforcements, and, more particularly, to two-piece porthole reinforcements configured to attach to a telecommunications pole.

### BACKGROUND

Due to the continually-increasing demand in the telecommunications industry for wireless coverage, carriers have to install a greater amount of equipment on existing telecommunications poles to keep up with demand. When new equipment is installed on such poles, portholes must be cut through the exterior of the telecommunications pole so that cable can extend through the porthole from the interior of the pole and connect to devices, such as antenna, attached to the exterior of the pole. However, cutting portholes through a telecommunications pole creates an inherent structural weakness in the pole in the vicinity of the porthole. To address this issue, reinforcements can be attached to the pole around the porthole. Currently, such reinforcements are typically one-piece structures that are welded to the telecommunications pole around the porthole. However, to attach such a reinforcement requires performing elevated welding at the site of the porthole, which can be dangerous for the welder and risk igniting the cables disposed within the telecommunications pole. Further, such one-piece designs can be difficult to match with the shape of an existing pole or the porthole cut through the pole.

As a result, there is a need for a porthole reinforcement that can accommodate a variety of telecommunications pole shapes and does not require elevated welding for attachment.

### SUMMARY

An aspect of the present disclosure is a porthole reinforcement configured to attach to a telecommunications pole defining a porthole. The porthole reinforcement includes a first reinforcement segment comprising a first gusset configured to at least partially extend through the porthole and a first plate attached to the first gusset, where the first plate defines a first plurality of bores each configured to receive a respective bolt so as to couple the first reinforcement segment to the telecommunications pole. The porthole reinforcement also includes a second reinforcement segment comprising a second gusset configured to at least partially extend through the porthole and a second plate attached to the second gusset, where the second plate defines a second plurality of bores each configured to receive a respective bolt so as to couple the second reinforcement segment to the telecommunications pole. The first and second reinforcement segments are configured to attach to the telecommunications pole independently from each other.

Another aspect of the present disclosure is a method of attaching a porthole reinforcement to a telecommunications pole. The method includes cutting a porthole through a telecommunications pole and attaching a first reinforcement segment to the telecommunications pole, where the first reinforcement segment comprises a first plate and a first gusset attached to the first plate, such that the first plate is positioned adjacent the porthole and the first gusset at least partially extends through the porthole. The method also includes attaching a second reinforcement segment to the telecommunications pole independent from attaching the first reinforcement segment, where the second reinforcement segment comprises a second plate and a second gusset attached to the second plate, such that the second plate is positioned adjacent the porthole and the second gusset at least partially extends through the porthole.

### BRIEF DESCRIPTION OF THE DRAWINGS

The foregoing summary, as well as the following detailed description, will be better understood when read in conjunction with the appended drawings. The drawings show illustrative aspects of the disclosure. It should be understood, however, that the application is not limited to the precise arrangements and instrumentalities shown.

FIG. 1 illustrates a perspective view of a porthole reinforcement according to an aspect of the present disclosure;

FIG. 2 illustrates an exploded view of the porthole reinforcement shown in FIG. 1;

FIG. 3 illustrates a perspective view of the porthole reinforcement and a telecommunications pole defining a porthole, with the porthole reinforcement detached from the telecommunications pole;

FIG. 4 illustrates a perspective view of the porthole reinforcement and telecommunications pole, with the porthole reinforcement attached to the telecommunications pole; and

FIG. 5 illustrates a process flow diagram of a method of attaching the porthole reinforcement to the telecommunications pole according to an aspect of the present disclosure.

### DETAILED DESCRIPTION OF ILLUSTRATIVE ASPECTS

Described herein is a porthole reinforcement 10 configured to attach to a telecommunications pole 175 defining a porthole 187. Certain terminology is used to described the porthole reinforcement 10 in the following description for convenience only and is not limiting. The words “right”, “left”, “lower,” and “upper” designate directions in the drawings to which reference is made. The words “inner” and “outer” refer to directions toward and away from, respectively, the geometric center of the description to describe the porthole reinforcement 10 and related parts thereof. The terminology includes the above-listed words, derivatives thereof, and words of similar import.

Unless otherwise specified herein, the terms “longitudinal,” “lateral,” and “vertical” are used to describe the orthogonal directional components of various components of the porthole reinforcement 10 as designated by the longitudinal direction 2, lateral direction 4, and vertical direction 6. It should be appreciated that while the longitudinal and lateral directions 2, 4 are illustrated as extending along a horizontal plane, and the vertical direction 6 is illustrated as extending along a vertical plane, the planes that encompass the various directions may differ during use.

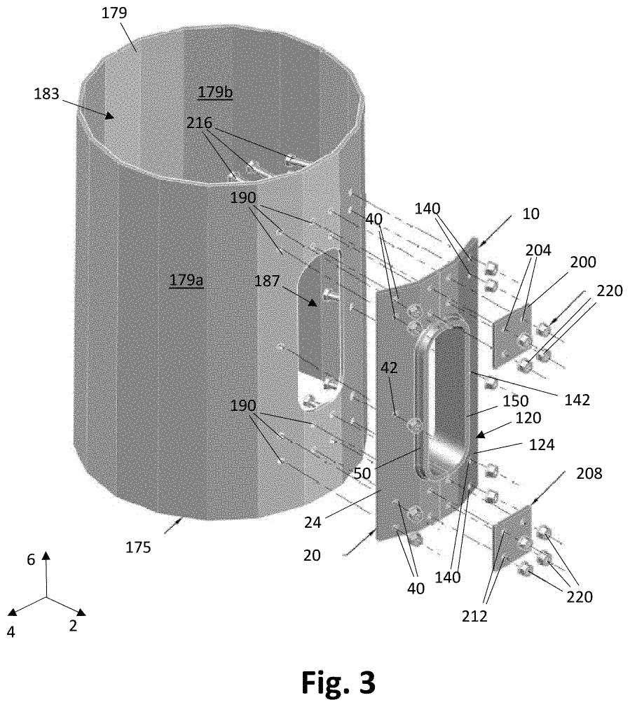

Referring to FIG. 3, the porthole reinforcement 10 can be configured to attach to a telecommunications pole 175 defining a porthole 187. The telecommunications pole 175 can be a monopole, though it is contemplated that the porthole reinforcement 10 can be utilized with other types of telecommunications poles. The telecommunications pole 175 can have a substantially hollow body 179 that has an outer surface 179a and an inner surface 179b opposite the outer surface 179a. The body 179 can define a channel 183 extending therethrough along the vertical direction 6, where the inner surface 179b of the body 179 faces the channel 183. To allow for cables to pass through the body 179 of the telecommunications pole 175 and connect to devices (not shown) attached to the exterior of the telecommunications pole 175, a porthole 187 can be cut through the body 179 of the telecommunications pole 175, such that the porthole 187 extends from the outer surface 179a to the inner surface 179b. The porthole 187 can define a particular shape when viewed along the longitudinal direction 2. In the depicted aspect, the shape of the porthole 187 can be a rounded rectangle. However, the porthole 187 can define other shapes as required, such as a square, rectangle, oval, circle, etc.

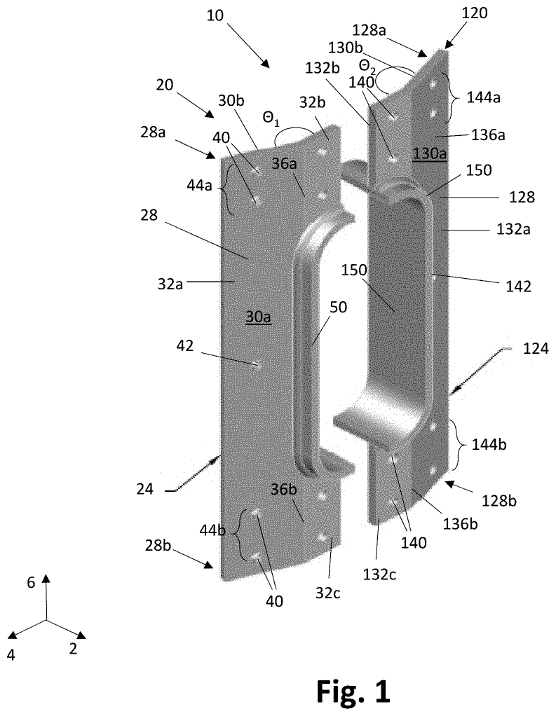

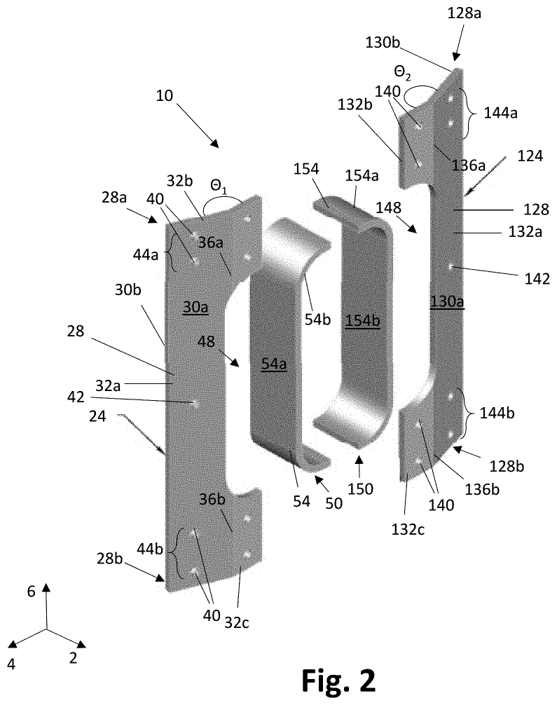

Now referring to FIGS. 1-2, the porthole reinforcement 10 will be described in greater detail. The porthole reinforcement 10 can be comprise a first reinforcement segment 20 and a second reinforcement segment 120, where each of the first and second reinforcement segments 20, 120 will be described in turn. The first reinforcement segment 20 can include a first plate 24 and a first gusset 50. The first plate 24 can have a body 28 that defines an upper end 28a and a lower end 28b opposite the upper end 28a along the vertical direction 6. The body 28 of the first plate 24 can also have an outer surface 30a and an inner surface 30b opposite the outer surface 30a. The first plate 24 can be comprised of a metal, such as steel, and can define a thickness measured from the outer surface 30a to the inner surface 30b that is from about 0.5 inches to about 0.75 inches. However, other thicknesses outside this range are contemplated. The body 28 of the first plate 24 can be comprised of a plurality of differentiable portions. For example, the first plate 24 can define a first portion 32a that extends from the upper end 28a of the body 28 to the lower end 28b of the body 28. The first portion 32a can define the left side of the first plate 24 when viewing the outer surface 30a of the first plate 24 along the longitudinal direction 2.

The body 28 of the first plate 24 can also define a second portion 32b extending from the first portion 32a at a first bend line 36a. In the depicted aspect, the second portion 32b extends substantially to the right along the lateral direction 4 from the first portion 32a when viewing the outer surface 30a of the first plate 24 along the longitudinal direction 2. Further, the bend line 36a is shown as extending substantially along the vertical direction 6. However, other orientations and configurations of the second portion 32b and the bend line 36a are contemplated. The first portion 32a can be angularly offset from the second portion 32b about the first bend line 36a by a first angle Θ₁. The first angle Θ₁ can be from about 150 degrees to about 160 degrees. However, the first angle Θ₁ can be more than 160 degrees or less than 150 degrees in other aspects. The first bend line 36a can define a sharp transition between the first portion 32a and the second portion 32b of the body 28. Alternatively, the first bend line 36a can define a gradual, rounded transition between the first and second portions 32a, 32b.

The body 28 of the first plate 24 can further define a third portion 32c extending from the first portion 32a at a second bend line 36b. In the depicted aspect, like the second portion 32b, the third portion 32c extends substantially to the right along the lateral direction 4 from the first portion 32a when viewing the outer surface 30a of the first plate 24 along the longitudinal direction 2. The third portion 32c can be spaced from the second portion 32b along the vertical direction 6. The second bend line 36b is shown as extending substantially along the vertical direction 6. However, other orientations and configurations of the third portion 32c and the second bend line 36b are contemplated. The first portion 32a can be angularly offset from the third portion 32c about the second bend line 36b by the first angle Θ₁. However, the angle by which the third portion 32c is offset from the first portion 32a can be different than the angle by which the second portion 32b is offset from the first portion 32a. The second bend line 36b can define a sharp transition between the first portion 32a and the third portion 32c of the body 28. Alternatively, the second bend line 36b can define a gradual, rounded transition between the first and third portions 32a, 32c.

The first, second, and third portions 32a-32c of the body 28 can collectively define a first gap 48 that extends through the body 28. Specifically, the first gap 48 can extend from the outer surface 30a to the inner surface 30b of the body 28, and can be positioned such that, when viewing the outer surface 30a of the first plate 24 along the longitudinal direction 2, the first portion 32a defines the left side of the gap 48, the second portion 32b defines the upper side of the gap 48, and the third portion 32c defines the lower side of the gap 48, and the gap 48 has an open right side. In other words, the gap 48 extends into the body 28 from its right side.

The first plate 24 can also define a plurality of bores 40 each configured to receive a respective bolt 216 so as to couple the first reinforcement segment 20 to the telecommunications pole 175, as will be described further below. The bores 40 can extend through the body 28 from the outer surface 30a to the inner surface 30b. Though each of the bores 40 is depicted as being similarly sized and shaped, each of the bores 40 can be differently configured as desired. Further, the plurality of bores 40 can be separated into a first group of bores 44a that extend through the upper end 28a of the first plate 24 and a second group of bores 44b that extend through the lower end 28b of the first plate 24. As such, the first group of bores 44a can be spaced from the second group of bores 44b along the vertical direction 6. The first group of bores 44a can extend through parts of the first and second portions 32a, 32b of the first plate 24, while the second group of bores 44b can extend through parts of the first and third portions 32a, 32c of the first plate 24. Each of the first and second groups of bores 44a, 44b can each comprise at least four bores 40. In other aspects, each of the first and second groups of bores 44a, 44b can comprise six bores 40, eight bores 40, ten bores 40, etc. In the depicted aspect, none of the bores 40 of the first and second groups of bores 44a, 44b are laterally aligned with the first gap 48. Further, the bores 40 of each of the first and second groups of bores 44a, 44b can be arranged in a particular pattern, such as a 2×2 grid. However, it is contemplated that the bores 40 can define other patterns, such as a 2×3 grid, 3×2 grid, 3×3 grid, 4×2 grid, 2×4 grid, etc. Though shown as having an equal number of bores 40 and a similar arrangement of bores 40, it is contemplated that the first and second groups of bores 44a, 44b can define different numbers of bores 40 and/or different arrangements of bores 40 as desired.

The first plate 24 can also include a central bore 42 that extends through the first portion 32a of the first plate 24 and is configured to receive a bolt 216 so as to further couple the first reinforcement segment 20 to the telecommunications pole 175. The central bore 42 can be positioned between the first and second groups of bores 44a, 44b along the vertical direction 6. In the depicted aspect, the central bore 42 is the only bore that is positioned vertically between the first and second of bores groups 44a, 44b. As a result, the central bore 42 can be the only bore that is laterally aligned with the first gap 48. Further, the central bore 42 can be equidistantly spaced between the first and second groups of bores 44a, 44b.

As stated above, the first reinforcement segment 20 can also include a first gusset 50 attached to the first plate 24 and configured to at least partially extend through the porthole 187, as will be described below. Specifically, the first gusset 50 can be disposed within the first gap 48 defined by the first plate 24. In one aspect, the first gusset 50 is welded to the first plate 24, though other means of attaching the first gusset 50 and the first plate 24 are contemplated. The first gusset 50 can define a body 54 that has an inner surface 54a and an outer surface 54b opposite the inner surface 54a. When attached to the first plate 24, the inner surface 54a of the first gusset 50 can contact the first plate 24. The first gusset 50 can be in contact with each of the first, second, and third portions 32a-32c of the first plate 24. However, it is contemplated that the first gusset 50 can be in contact with any combination of the first, second, and third portions 32a-32c.

Continuing with FIGS. 1-2, the second reinforcement segment 120 will be described in detail. The second reinforcement segment 120 can include a second plate 124 and a second gusset 150. The second plate 124 can have a body 128 that defines an upper end 128a and a lower end 128b opposite the upper end 128a along the vertical direction 6. The body 128 of the second plate 124 can also have an outer surface 130a and an inner surface 130b opposite the outer surface 130a. The second plate 124 can be comprised of a metal, such as steel, and can define a thickness measured from the outer surface 130a to the inner surface 130b that is from about 0.5 inches to about 0.75 inch. However, other thicknesses outside this range are contemplated. The body 128 of the second plate 124 can be comprised of a plurality of differentiable portions. For example, the second plate 124 can define a first portion 132a that extends from the upper end 128a of the body 128 to the lower end 128b of the body 128. The first portion 132a can define the right side of the second plate 124 when viewing the outer surface 130a of the second plate 124 along the longitudinal direction 2.

The body 128 of the second plate 124 can also define a second portion 132b extending from the first portion 132a at a first bend line 136a. In the depicted aspect, the second portion 132b extends substantially to the left along the lateral direction 4 from the first portion 132a when viewing the outer surface 130a of the second plate 124 along the longitudinal direction 2. Further, the first bend line 136a is shown as extending substantially along the vertical direction 6. However, other orientations and configurations of the second portion 132b and the first bend line 136a are contemplated. The first portion 132a can be angularly offset from the second portion 132b about the first bend line 136a by a second angle Θ₂. The second angle Θ₂ can be from about 150 degrees to about 160 degrees. However, the second angle Θ₂ can be more than 160 degrees or less than 150 degrees in other aspects. Additionally, the first and second angles Θ₁, Θ₂ can be the same or different as desired. The first bend line 136a can define a sharp transition between the first portion 132a and the second portion 132b of the body 128. Alternatively, the first bend line 136a can define a gradual, rounded transition between the first and second portions 132a, 132b.

The body 128 of the second plate 124 can further define a third portion 132c extending from the first portion 132a at a second bend line 136b. In the depicted aspect, like the second portion 132b, the third portion 132c extends substantially to the left along the lateral direction 4 from the first portion 132a when viewing the outer surface 130a of the first plate 124 along the longitudinal direction 2. The third portion 132c can be spaced from the second portion 132b along the vertical direction 6. The second bend line 136b is shown as extending substantially along the vertical direction 6. However, other orientations and configurations of the third portion 132c and the second bend line 136b are contemplated. The first portion 132a can be angularly offset from the third portion 132c about the second bend line 136b by the second angle Θ₂. However, the angle by which the third portion 132c is offset from the first portion 132a can be different than the angle by which the second portion 132b is offset from the first portion 132a. The second bend line 136b can define a sharp transition between the first portion 132a and the third portion 132c of the body 128. Alternatively, the second bend line 136b can define a gradual, rounded transition between the first and third portions 132a, 132c.

The first, second, and third portions 132a-132c of the body 128 can collectively define a second gap 148 that extends through the body 128. Specifically, the second gap 148 can extend from the outer surface 130a to the inner surface 130b of the body 128, and can be positioned such that, when viewing the outer surface 130a of the first plate 124 along the longitudinal direction 2, the first portion 132a defines the right side of the gap 148, the second portion 132b defines the upper side of the gap 148, and the third portion 132c defines the lower side of the gap 148, and the gap 148 has an open left side. In other words, the gap 148 extends into the body 128 from its left side.

The second plate 124 can also define a plurality of bores 140 each configured to receive a respective bolt 216 so as to couple the first reinforcement segment 20 to the telecommunications pole 175, as will be described further below. The bores 140 can extend through the body 128 from the outer surface 130a to the inner surface 130b. Though each of the bores 140 is depicted as being similarly sized and shaped, each of the bores 140 can be differently configured as desired. Further, the plurality of bores 140 can be separated into a first group of bores 144a that extend through the upper end 128a of the second plate 124 and a second group of bores 144b that extend through the lower end 128b of the second plate 124. As such, the first group of bores 144a can be spaced from the second group of bores 144b along the vertical direction 6. The first group of bores 144a can extend through parts of the first and second portions 132a, 132b of the second plate 124, while the second group of bores 144b can extend through parts of the first and third portions 132a, 132c of the second plate 124. Each of the first and second groups of bores 144a, 144b can each comprise at least four bores 140. In other aspects, each of the first and second groups of bores 144a, 144b can comprise six bores 140, eight bores 140, ten bores 140, etc. In the depicted aspect, none of the bores 140 of the first and second groups of bores 144a, 144b are laterally aligned with the first gap 148. Further, the bores 140 of each of the first and second groups of bores 144a, 144b can be arranged in a particular pattern, such as a 2×2 grid. However, it is contemplated that the bores 140 can define other patterns, such as a 2×3 grid, 3×2 grid, 3×3 grid, 4×2 grid, 2×4 grid, etc. Though shown as having an equal number of bores 140 and a similar arrangement of bores 140, it is contemplated that the first and second groups of bores 144a, 144b can define different numbers of bores 140 and/or different arrangements of bores 140 as desired.

The first plate 124 can also include a central bore 142 that extends through the first portion 132a of the second plate 124 and is configured to receive a bolt 216 so as to further couple the second reinforcement segment 120 to the telecommunications pole 175. The central bore 142 can be positioned between the first and second groups of bores 144a, 144b along the vertical direction 6. In the depicted aspect, the central bore 142 is the only bore that is positioned vertically between the first and second groups 144a, 144b of bores 140. The central bore 142 can also be the only bore laterally aligned with the second gap 148. Further, the central bore 142 is equidistantly spaced between the first and second groups of bores 144a, 144b.

As stated above, the second reinforcement segment 120 can also include can include a second gusset 150 attached to the second plate 124 and configured to at least partially extend through the porthole 187, as will be described below. Specifically, the second gusset 150 can be disposed within the second gap 148 defined by the second plate 124. In one aspect, the second gusset 150 is welded to the second plate 124, though other means of attaching the second gusset 150 and the second plate 124 are contemplated. The second gusset 150 can define a body 154 that has an inner surface 154a and an outer surface 154b opposite the inner surface 154a. When attached to the second plate 124, the inner surface 154a of the second gusset 150 can contact the second plate 124. The second gusset 150 can be in contact with each of the first, second, and third portions 132a-132c of the second plate 124. However, it is contemplated that the second gusset 150 can be in contact with any combination of the first, second, and third portions 132a-132c.

As shown and described, the first and second reinforcement segments 20, 120 can be substantially identical mirror images of each other. However, various features of the first and second reinforcement segments 20, 120 can differ in operation. For example, the first and second gaps 48, 148 can be differently sized, the angles between the various portions of the first and second reinforcement segments 20, 120 can differ, and the number of bores 40, 140 extending through each of the first and second reinforcement segments 20, 120 can differ. Additionally, the shape and size of any number of other shared features between the first and second reinforcement segments 20, 120 can differ in other aspects.

In operation, the porthole reinforcement 10 can be attached to the telecommunications pole 175 so as to strengthen the portion of the telecommunications pole 175 through which the porthole 187 extends. When attaching the porthole reinforcement 10, the first and second reinforcement segments 20, 120 are configured to attach to the telecommunications pole 175 independently from each other. In other words, each of the first and second reinforcement segments 20, 120 have no direct effect on the other's attachment to the telecommunications pole 175. As a result, the first reinforcement segment 20 can be attached to the telecommunications pole 175 before the second reinforcement segment 120, or the second reinforcement segment 120 can be attached to the telecommunications pole 175 before the first reinforcement segment 20.

To attach the first reinforcement segment 20 to the telecommunications pole 175, the first plate 24 can be placed into contact with the outer surface 179a of the telecommunications pole 175 adjacent the porthole 187. Specifically, the first plate 24 can be positioned such that the plurality of bores 40 and the central bore 42 are aligned with a corresponding plurality of bores 190 that extend through the body 179 of the telecommunications pole 175 from the outer surface 179a to the inner surface 179b. Accordingly, the arrangement of the bores 190 on the telecommunications pole 175 can substantially align with the plurality of bores 40, 140 and the central bores 42, 142 of the first and second reinforcement segments 20, 120, respectively. Additionally, the first gap 48 can be aligned with the porthole 187. As a result, the first gusset 50 can extend at least partially through the porthole 187.

Similarly, to attach the second reinforcement segment 120 to the telecommunications pole 175, the second plate 124 can be placed into contact with the outer surface 179a of the telecommunications pole 175 adjacent the porthole 187 and opposite the first reinforcement segment 24. Specifically, the second plate 124 can be positioned such that the plurality of bores 140 and the central bore 142 are aligned with a corresponding plurality of bores 190. Additionally, the second gap 148 can be aligned with the porthole 187. As a result, like the first gusset 50, the second gusset 150 can extend at least partially through the porthole 187. The first and second gaps 48, 148 can collectively define a shape that is substantially identical to the shape of the porthole 187. The various potential shapes for the porthole 187 have been described previously.

The two-piece construction of the porthole reinforcement 10 is advantageous as it allows each of the first and second reinforcement segments 20, 120 to be individually positioned against the particular telecommunications pole 175 at issue so as to account for dimensional and/or shape differences between different poles. As a result, the first reinforcement segment 20 can be configured to contact the second reinforcement segment 120 when the first and second reinforcement segments 20, 120 are attached to the telecommunications pole 175. In other aspects (and potentially to accommodate differently sized telecommunications poles), the first reinforcement segment 20 can be spaced in an entirety from the second reinforcement segment 120 when the first and second reinforcement segments 20, 120 are attached to the telecommunications pole 175. Additionally, when the first and second reinforcement segments 20, 120 are attached to the telecommunications pole 175, the first and second gussets 48, 148 can be configured to contact the body 179 around the perimeter of the porthole 187. Alternatively, one or both of the first and second gussets 50, 150 can be spaced (partially or in an entirety) from the body 179 of the telecommunications pole 175. For example, a gap can be defined between the first gusset 48 and the body 179 and/or the second gusset 148 and the body 179 that is between 1/16 inches and ⅛ inches. In contrast, in reinforcements utilizing a one-piece design, any difference in dimensions and shapes between various telecommunications pole will result in a less close fit between the reinforcement and the pole, thus comprising the reinforcing abilities of the porthole reinforcement.

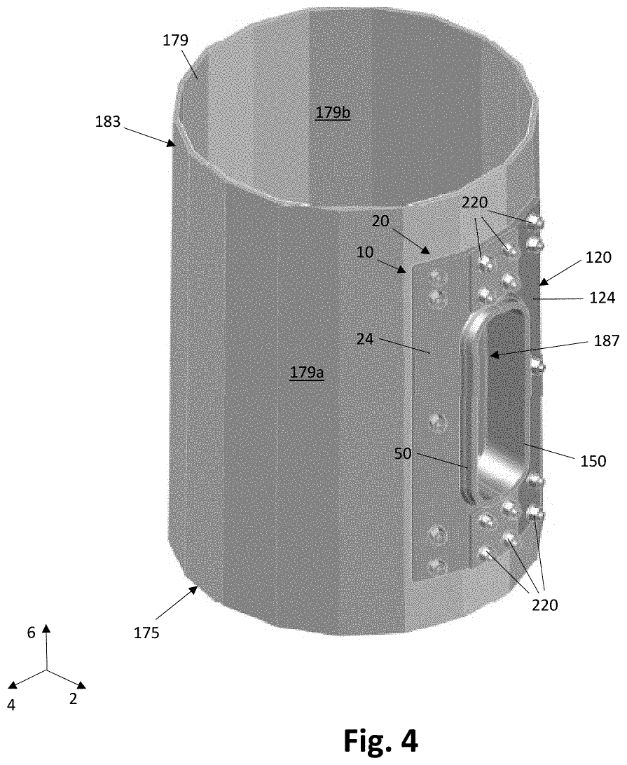

As shown in FIGS. 3-4, to physically secure the first and second reinforcement segments 20, 120 to the telecommunications pole 175, a plurality of bolts 216 can be disposed through the plurality of bores 40, 140 and the central bores 42, 142 of the first and second reinforcement segments 20, 120 and through corresponding bores 190 of the telecommunications pole 175. After being disposed through the bores, each of the bolts 216 can threadedly receive a corresponding nut 220. As a result, the nuts 220 will secure the bolts 216 to the telecommunications pole 175 and the first and second reinforcement segments 20, 120. As described above, the first groups of bores 44a, 144a and the second groups of bores 44b, 144b are concentrated at the upper and lower ends 28a, 28b of the first and second reinforcement segments 20, 120. Because of this arrangement of the bores, the first and second reinforcement segments 20, 120 are configured to transfer loads applied to the telecommunications pole 175 from an upper portion of the telecommunications pole 175 above the porthole 187 to a lower portion of the telecommunications pole 175 below the porthole 187 through the bolts 216. The bolts 216 that extend through the respective central bores 42, 142 reduce the unsupported length of the porthole reinforcement 10.

To resist the effects of a force applied to the porthole reinforcement 10 along the lateral direction 4, the porthole reinforcement 10 can further include first and second cover plates 200, 208. The first cover plate 200 can define a square plate having a plurality of bores 204 extending therethrough. Similarly, the second cover plate 208 can define a square plate having a plurality of bores 212 extending therethrough. Though depicted as having a square shape, in alternative aspects the first and second cover plates 200, 208 can be shaped as rectangles, ovals, circles, etc. Additionally, each of the first and second cover plates 200, 208 is depicted as defining four bores 204, 212, respectively. However, each of the first and second cover plates 200, 208 can have more or less than four bores 204, 212, such as two bores, three bores, five bores, six bores, etc. When attaching the first and second reinforcement segments 20, 120 to the telecommunications pole, a first bore 204 of the first cover plate 200 can be aligned with one of the bores 40 of the upper group of bores 44a and a second bore 204 of the first cover plate 200 can be aligned with one of the bores 40 of the upper group of bores 144a so as to receive bolts 216 to attach the first cover plate 200 to the first and second reinforcement segments 20, 120. However, multiple bores 204 of the first cover plate 200 can align with bores 40 of the upper groups of bores 44a, 144a, respectively. Similarly, a first bore 212 of the second cover plate 208 can be aligned with one of the bores 40 of the lower group of bores 44b and a second bore 212 of the second cover plate 208 can be aligned with one of the bores 40 of the lower group of bores 144b so as to receive bolts 216 to attach the second cover plate 208 to the first and second reinforcement segments 20, 120. However, multiple bores 212 of the second cover plate 208 can align with the bores 40 of the lower groups of bores 44a, 144b.

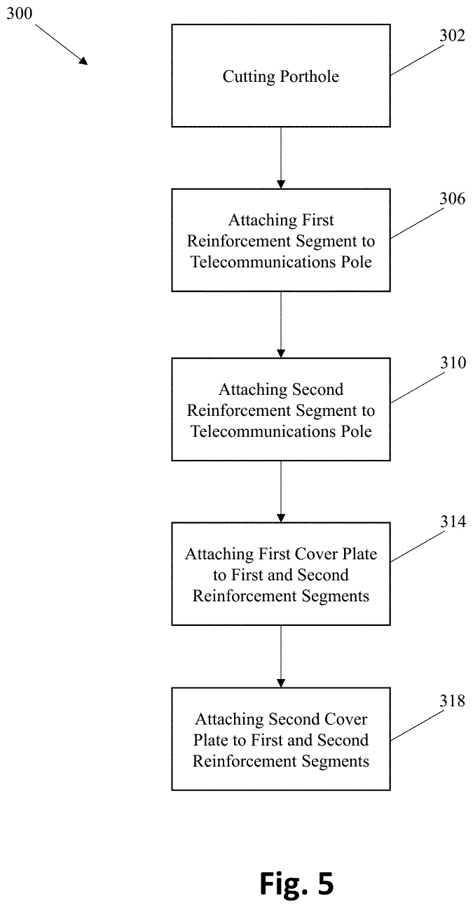

Now referring to FIG. 5, a method 300 of attaching the porthole reinforcement 10 to the telecommunications pole 175 will be described. The method 300 can begin with cutting the porthole 187 through the telecommunications pole 175 in step 302. Then, in step 306, the first reinforcement segment 20 can be attached to the telecommunications pole 175 such that the first plate 24 is positioned adjacent the porthole 187 and the first gusset 50 at least partially extends through the porthole 187. In step 310, the second reinforcement segment 120 can be attached to the telecommunications pole 175 independent from attaching the first reinforcement segment 20 such that the second plate 124 is positioned adjacent the porthole 187 and the second gusset 150 at least partially extends through the porthole 187. Though steps 306 and 310 are shown and described in a particular order, their order can be reversed as desired. Step 306 can include bolting the first reinforcement segment 20 to the telecommunications pole 175. Likewise, step 310 can include bolting the second reinforcement segment 120 to the telecommunications pole 175. Then, in step 314 a first cover plate 200 is attached to the first and second reinforcement segments 20, 120. Similarly, in step 318 a second cover plate is attached to the first and second reinforcement segments 20, 120.

### Aspects of the Disclosure

In various aspects, the present disclosure pertains to and includes at least the following aspects.

Aspect 1. A porthole reinforcement configured to attach to a telecommunications pole defining a porthole, the porthole reinforcement comprising:

a first reinforcement segment comprising a first gusset configured to at least partially extend through the porthole and a first plate attached to the first gusset, wherein the first plate defines a first plurality of bores each configured to receive a respective bolt so as to couple the first reinforcement segment to the telecommunications pole; and

a second reinforcement segment comprising a second gusset configured to at least partially extend through the porthole and a second plate attached to the second gusset, wherein the second plate defines a second plurality of bores each configured to receive a respective bolt so as to couple the second reinforcement segment to the telecommunications pole,

wherein the first and second reinforcement segments are configured to attach to the telecommunications pole independently from each other.

Aspect 2. The porthole reinforcement of Aspect 1, wherein the first and second reinforcement segments are configured to transfer loads applied to the telecommunications pole from an upper portion of the telecommunications pole above the porthole to a lower portion of the telecommunications pole below the porthole.

Aspect 3. The porthole reinforcement of Aspect 1, wherein the first plate defines a body having a first portion and a second portion extending from the first portion at a first bend line, wherein the first portion is angularly offset from the second portion about the first bend line by a first angle.

Aspect 4. The porthole reinforcement of Aspect 3, wherein the second plate defines a body having a first portion and a second portion extending from the first portion at a second bend line, wherein the first portion of the second plate is angularly offset from the second portion of the second plate about the second bend line by a second angle.

Aspect 5. The porthole reinforcement of Aspect 4, wherein the first and second angles are from about 150 degrees to about 160 degrees.

Aspect 6. The porthole reinforcement of Aspect 1, wherein the first plate defines a body having a first portion, a second portion extending from the first portion along a lateral direction, and a third portion extending from the first portion along the lateral direction and spaced from the second portion along a vertical direction that is perpendicular to the lateral direction, wherein the first, second, and third portions collectively define a first gap that extends through the body.

Aspect 7. The porthole reinforcement of Aspect 6, wherein the first gap is configured to align with the porthole when the first reinforcement segment is attached to the telecommunications pole.

Aspect 8. The porthole reinforcement of Aspect 6, wherein the first gusset is disposed within the first gap.

Aspect 9. The porthole reinforcement of Aspect 6, wherein the second plate defines a body having a first portion, a second portion extending from the first portion along the lateral direction, and a third portion extending from the first portion along the lateral direction and spaced from the second portion along the vertical direction, wherein the first, second, and third portions of the second plate collectively define a second gap that extends through the body of the second plate.

Aspect 10. The porthole reinforcement of Aspect 9, wherein the second gap is configured to align with the porthole when the second reinforcement segment is attached to the telecommunications pole.

Aspect 11. The porthole reinforcement of Aspect 9, wherein the second gusset is disposed within the second gap.

Aspect 12. The porthole reinforcement of Aspect 9, wherein the first and second gaps collectively define a shape that is substantially identical to a shape of the porthole.

Aspect 13. The porthole reinforcement of Aspect 1, wherein each of the first and second plates defines an upper end and a lower end opposite the upper end along a vertical direction,

wherein the first plurality of bores comprises a first group of bores positioned at the upper end of the first plate and a second group of bores positioned at the lower end of the first plate, and

wherein the second plurality of bores comprises a first group of bores positioned at the upper end of the second plate and a second group of bores positioned at the lower end of the second plate.

Aspect 14. The porthole reinforcement of Aspect 13, wherein the first plate defines a first central bore positioned between the first and second groups of bores of the first plate along the vertical direction, and the second plate defines a second central bore positioned between the first and second groups of bores of the second plate along the vertical direction.

Aspect 15. The porthole reinforcement of Aspect 13, wherein each of the first and second groups of bores of the first and second plates comprises at least four bores.

Aspect 16. The porthole reinforcement of Aspect 15, wherein each of the first and second groups of bores of the first and second plates comprises at least six bores.

Aspect 17. The porthole reinforcement of Aspect 16, wherein each of the first and second groups of bores of the first and second plates comprises at least eight bores.

Aspect 18. The porthole reinforcement of Aspect 1, wherein the first reinforcement segment is configured to contact the second reinforcement segment when the first and second reinforcement segments are attached to the telecommunications pole.

Aspect 19. The porthole reinforcement of Aspect 1, wherein the first reinforcement segment is configured to be spaced in an entirety from the second reinforcement segment when the first and second reinforcement segments are attached to the telecommunications pole.

Aspect 20. The porthole reinforcement of Aspect 1, wherein the first gusset is welded to the first plate, and the second gusset is welded to the second plate.

Aspect 21. The porthole reinforcement of Aspect 1, further comprising: a first cover plate defining a first bore configured to align with one of the first plurality of bores and a second bore configured to align with at least one of the second plurality of bores.

Aspect 22. The porthole reinforcement of Aspect 21, further comprising: a second cover plate defining a first bore configured to align with one of the first plurality of bores and a second cover plate configured to align with at least one of the second plurality of bores.

Aspect 23. The porthole reinforcement of Aspect 1, wherein the telecommunications pole is a monopole.

Aspect 24. A method of attaching a porthole reinforcement to a telecommunications pole, the method comprising:

cutting a porthole through a telecommunications pole;

attaching a first reinforcement segment to the telecommunications pole, wherein the first reinforcement segment comprises a first plate and a first gusset attached to the first plate, such that the first plate is positioned adjacent the porthole and the first gusset at least partially extends through the porthole; and

attaching a second reinforcement segment to the telecommunications pole independent from attaching the first reinforcement segment, wherein the second reinforcement segment comprises a second plate and a second gusset attached to the second plate, such that the second plate is positioned adjacent the porthole and the second gusset at least partially extends through the porthole.

Aspect 25. The method of Aspect 24, wherein attaching the first reinforcement segment to the telecommunications pole comprises bolting the first reinforcement segment to the telecommunications pole,

wherein attaching the second reinforcement segment to the telecommunications pole comprises bolting the second reinforcement segment to the telecommunications pole.

Aspect 26. The method of Aspect 24, further comprising:

attaching a first cover plate to the first and second reinforcement segments.

Aspect 27. The method of Aspect 26, further comprising:

attaching a second cover plate to the first and second reinforcement segments.

Aspect 28. The method of Aspect 24, wherein the telecommunications pole is a monopole.

While various inventive aspects, concepts and features of the disclosures may be described and illustrated herein as embodied in combination in the exemplary aspects, these various aspects, concepts and features may be used in many alternative aspects, either individually or in various combinations and sub-combinations thereof. Unless expressly excluded herein all such combinations and sub-combinations are intended to be within the scope of the present disclosures. Still further, while various alternative aspects as to the various aspects, concepts, and features of the disclosures—such as alternative materials, structures, configurations, methods, devices and components, alternatives as to form, fit and function, and so on—may be described herein, such descriptions are not intended to be a complete or exhaustive list of available alternative aspects, whether presently known or later developed. Those skilled in the art may readily adopt one or more of the inventive aspects, concepts or features into additional aspects and uses within the scope of the present disclosures even if such aspects are not expressly disclosed herein. Still further, exemplary or representative values and ranges may be included to assist in understanding the present disclosure; however, such values and ranges are not to be construed in a limiting sense and are intended to be critical values or ranges only if so expressly stated. Descriptions of exemplary methods or processes are not limited to inclusion of all steps as being required in all cases, nor is the order that the steps are presented to be construed as required or necessary unless expressly so stated.

While the disclosure is described herein using a limited number of aspects, these specific aspects are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in a particular order as desired.

1. A porthole reinforcement configured to attach to a telecommunications pole defining a porthole, the porthole reinforcement comprising:
a first reinforcement segment comprising a first gusset configured to at least partially extend through the porthole and a first plate attached to the first gusset, wherein the first plate defines a first plurality of bores each configured to receive a respective bolt so as to couple the first reinforcement segment to the telecommunications pole; and
a second reinforcement segment comprising a second gusset configured to at least partially extend through the porthole and a second plate attached to the second gusset, wherein the second plate defines a second plurality of bores each configured to receive a respective bolt so as to couple the second reinforcement segment to the telecommunications pole,
wherein the first and second reinforcement segments are separate from each other and are configured to be fastened to the telecommunications pole independently from each other.

2. The porthole reinforcement of claim 1, wherein the first and second reinforcement segments are configured to transfer loads applied to the telecommunications pole from an upper portion of the telecommunications pole above the porthole to a lower portion of the telecommunications pole below the porthole.

3. The porthole reinforcement of claim 1, wherein the first plate defines a body having a first portion and a second portion extending from the first portion at a first bend line, wherein the first portion is angularly offset from the second portion about the first bend line by a first angle.

4. The porthole reinforcement of claim 3, wherein the second plate defines a body having a first portion and a second portion extending from the first portion at a second bend line, wherein the first portion of the second plate is angularly offset from the second portion of the second plate about the second bend line by a second angle.

5. The porthole reinforcement of claim 4, wherein the first and second angles are from about 150 degrees to about 160 degrees.

6. The porthole reinforcement of claim 1, wherein the first plate defines a body having a first portion, a second portion extending from the first portion along a lateral direction, and a third portion extending from the first portion along the lateral direction and spaced from the second portion along a vertical direction that is perpendicular to the lateral direction, wherein the first, second, and third portions collectively define a first gap that extends through the body.

7. The porthole reinforcement of claim 6, wherein the first gap is configured to align with the porthole when the first reinforcement segment is fastened to the telecommunications pole.

8. The porthole reinforcement of claim 6, wherein the second plate defines a body having a first portion, a second portion extending from the first portion along the lateral direction, and a third portion extending from the first portion along the lateral direction and spaced from the second portion along the vertical direction, wherein the first, second, and third portions of the second plate collectively define a second gap that extends through the body of the second plate.

9. The porthole reinforcement of claim 8, wherein the second gap is configured to align with the porthole when the second reinforcement segment is fastened to the telecommunications pole.

10. The porthole reinforcement of claim 8, wherein the first and second gaps collectively define a shape that is substantially identical to a shape of the porthole.

11. The porthole reinforcement of claim 1, wherein each of the first and second plates defines an upper end and a lower end opposite the upper end along a vertical direction,
wherein the first plurality of bores comprises a first group of bores positioned at the upper end of the first plate and a second group of bores positioned at the lower end of the first plate, and
wherein the second plurality of bores comprises a first group of bores positioned at the upper end of the second plate and a second group of bores positioned at the lower end of the second plate.

12. The porthole reinforcement of claim 11, wherein the first plate defines a first central bore positioned between the first and second groups of bores of the first plate along the vertical direction, and the second plate defines a second central bore positioned between the first and second groups of bores of the second plate along the vertical direction.

13. The porthole reinforcement of claim 11, wherein each of the first and second groups of bores of the first and second plates comprises at least four bores.

14. The porthole reinforcement of claim 1, wherein the first reinforcement segment is configured to contact the second reinforcement segment when the first and second reinforcement segments are fastened to the telecommunications pole.

15. The porthole reinforcement of claim 1, wherein the first reinforcement segment is configured to be spaced in an entirety from the second reinforcement segment when the first and second reinforcement segments are fastened to the telecommunications pole.

16. The porthole reinforcement of claim 1, wherein the first gusset is welded to the first plate, and the second gusset is welded to the second plate.

17. The porthole reinforcement of claim 1, further comprising:
a first cover plate defining a first bore configured to align with a first one of the first plurality of bores and a second bore configured to align with a first one of the second plurality of bores, and
a second cover plate defining a first bore configured to align with a second one of the first plurality of bores and a second bore configured to align with a second one of the second plurality of bores.

18. The porthole reinforcement of claim 1, wherein the telecommunications pole is a monopole.

19. A method of attaching a porthole reinforcement to a telecommunications pole, the method comprising:
cutting a porthole through a telecommunications pole;
fastening a first reinforcement segment to the telecommunications pole, wherein the first reinforcement segment comprises a first plate and a first gusset attached to the first plate, such that the first plate is positioned adjacent the porthole and the first gusset at least partially extends through the porthole; and
fastening a second reinforcement segment to the telecommunications pole independent from fastening the first reinforcement segment, wherein the second reinforcement segment comprises a second plate and a second gusset attached to the second plate, such that the second plate is positioned adjacent the porthole and the second gusset at least partially extends through the porthole.

20. The method of claim 19, wherein fastening the first reinforcement segment to the telecommunications pole comprises bolting the first reinforcement segment to the telecommunications pole,
wherein fastening the second reinforcement segment to the telecommunications pole comprises bolting the second reinforcement segment to the telecommunications pole.
